(19) United States
(12) Patent Application Publication
(10) Pub. No.: US 2005/0273560 A1
(43) Pub. Date: Dec. 8, 2005

(54) Method and apparatus to avoid incoherency between a cache memory and flash memory

(76) Inventors: Jared E. Hulbert, Shingle Springs, CA (US); Geoffrey A. Gould, El Dorado Hills, CA (US); Michael L. Edgington, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/861,266

(22) Filed: Jun. 3, 2004

(51) Int. Cl. G06F 12/00

(52) U.S. Cl. 711/133; 711/103; 711/135

(57) ABSTRACT

Briefly, in accordance with an embodiment of the invention, a method and apparatus to avoid incoherency between a cache memory and a flash memory is provided. The method may include invalidating at least one cache line of information stored in the cache memory to avoid incoherency between the cache memory and the flash memory in response to a flash erase operation, a flash write operation, an operation that makes information inaccessible in the flash memory, or an operation that moves information from one region of the flash memory to another region of the flash memory. Other embodiments are described and claimed.

### BACKGROUND

One type of memory is a flash electrically erasable programmable read-only memory (“flash EEPROM” or “flash memory”). Flash memories are non-volatile memories and once programmed, the flash memory may retain its data until the memory is erased. Electrical erasure of the flash memory may include erasing the contents of the memory of the device in one relatively rapid operation. The flash memory may then be programmed with new data.

Some of today's computing systems use a cache memory, which is generally a relatively faster and smaller type of memory and the performance of a computing system may be improved by the use of a cache memory. However, today's computing systems are not designed to cache all types of information stored in a flash memory.

Thus, there is a continuing need for alternate ways to cache information from a flash memory.

### BRIEF DESCRIPTION OF THE DRAWINGS

The subject matter regarded as the invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIG. 1 is a block diagram illustrating a computing system in accordance with an embodiment of the present invention;

FIG. 2 is a flow diagram illustrating a method in accordance with an embodiment of the present invention; and

FIG. 3 is a block diagram illustrating a wireless device in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

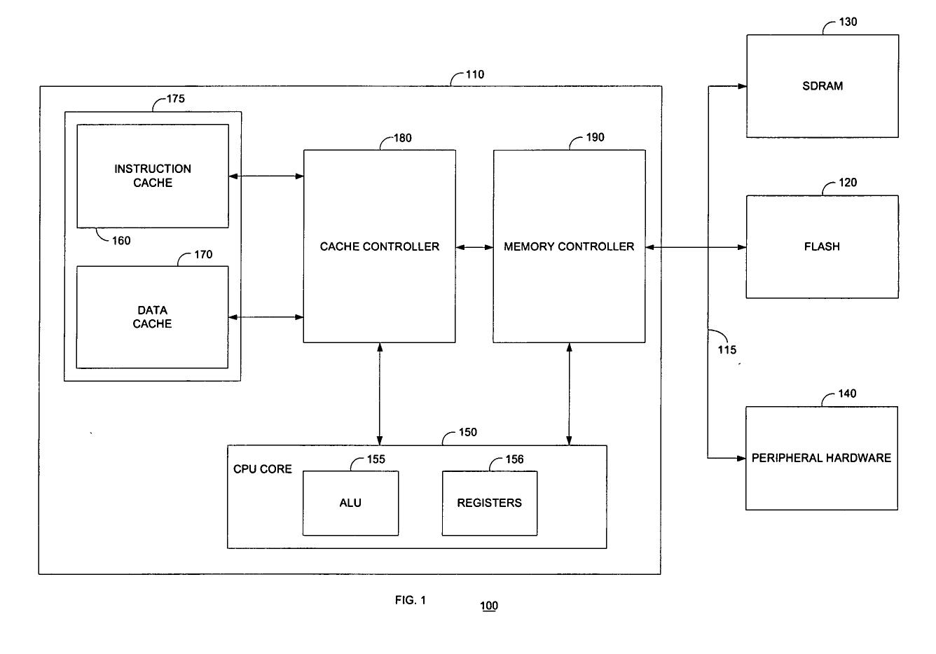

FIG. 1 is a block diagram illustrating a computing system 100 in which embodiments of the present invention may be used. Although the scope of the present invention is not limited in this respect, system 100 may be used in a laptop or desktop computer, a set-top box, a printer, a personal digital assistant (PDA), a wireless telephone (e.g., cordless or cellular phone), a pager, a digital music player, etc.

System 100 may include a processor 110 and a flash memory 120 coupled to processor 110 via a bus 115. Flash memory 120 may be a NAND or NOR type of flash memory, and may be a single bit per cell or multiple bits per cell memory. Flash memory 120 may store software instructions and/or data. The term “information” may be used to refer to data, instructions, or code. Flash memory 120 may comprise one or more chips or integrated circuits (ICs).

In addition, system 100 may further include a synchronous dynamic random access memory (SDRAM) 130 and a peripheral hardware device 140 also coupled to processor 110 via a bus 115. Although the scope of the present invention is not limited in this respect, peripheral hardware device 140 may be a memory-mapped input/output (I/O) device. In various embodiments, peripheral hardware device 140 may be a digital camera, Ethernet receiver, an infrared receiver (IR) remote controller, etc. Bus 115 may include one or more busses and may be a single 16-bit bus in one embodiment. Although not shown, system 100 may include other components such as, for example, more processors, input/output (I/O) devices, memory devices, or storage devices. However, for simplicity these additional components have not been shown.

Processor 110 may include digital logic to execute software instructions and may also be referred to as a central processing unit (CPU). Software instructions may also be referred to as code. Processor 110 may include a CPU core 150 that may comprise an arithmetic-logic unit (ALU) 155 and registers 156. In one embodiment, processor 110 may be an XScale® processor available from Intel® Corporation (both XScale and Intel are a registered trademarks of Intel Corporation). XScale includes an ARM based core, although the scope of the present invention is not limited in this respect. Embodiments of the present invention may be used with other processors having cores other than an ARM based core, e.g., a MIPS based core, x86 based core, etc.

Processor 110 may further include an instruction cache 160, a data cache 170, a cache controller 180 and a memory controller 190. Instruction cache 160 and data cache 170 may collectively be referred to as a cache memory 175. Memory controller 190 may be digital logic adapted to control memory accesses to memory-mapped devices that are coupled to processor 110, such as, for example, SDRAM 130, flash memory 120, and peripheral hardware device 140. Cache controller 180 may be used to assist in the processing of memory accesses and to control caching of information using the instruction cache 160 and data cache 170.

Information may be organized in flash memory as a file system. Further, different types of information may be stored in flash memory 120. For example, both static and dynamic information may be stored in flash memory 120. Static or non-alterable information may include read-only data and read-only code and may refer to any information stored in flash memory 120 that may not be altered, changed or updated. Examples of static data may include, but are not limited to, a serial number of a device or encryption keys. Examples of static code may include, but are not limited to, non-alterable initial boot code, hardware specific code, or a non-alterable operating system (O/S).

Dynamic information may also be referred to as alterable or non-static information and may refer to any information stored in the flash that may be altered, changed, or updated. Examples of dynamic data may include, but are not limited to, a java applet, ring tone data, or telephone number data. Examples of dynamic code may include, but are not limited to, a software application (e.g., new downloadable computer game) or an operating system (O/S) that may be, e.g., updated in response to a virus or a patch to fix bugs in the earlier version of the O/S. The dynamic information may also be referred to as read/write content.

A memory access to flash memory may include read, write, or erase operations. For example, to write information to flash memory 120, a memory address or an address range may be provided to memory controller 190. Memory controller 190 may have a memory map that includes the physical addresses for all memory-mapped devices coupled to processor 110. Memory controller 190 may use the address and memory map to write information to flash memory 120, e.g., memory controller 190 may provide the address to the address pins (not shown) of flash memory 120 via bus 115 and may provide the information to be written to the data pins (not shown) of flash memory 120 via bus 115. A write operation to flash memory 120 may also be referred to as programming flash memory 120.

The hardware of some of today's processors do not automatically maintain coherency with all types of external memory (e.g., flash memory). In one embodiment, software (e.g., a module of the O/S or a flash driver) may be modified or added in order to maintain coherency between flash memory 120 and the cache memory of processor 110. For example, code may be implemented to add mapping to allow processor 110 to read information stored in flash memory 120 from a duplicate copy stored in cache memory 175. In addition, code may be added to invalidate portions of cache memory 175, e.g. cache lines, that are affected by a write operation or an erase operation to flash memory 120. Coherency may mean that for any valid flash information that is cached in cache memory 175, a duplicate copy of the cached flash information is stored in flash memory 120.

In one embodiment, a method to maintain cache coherency with a read/write memory system is provided. The method may include initiating a request to invalidate any cache lines stored in cache memory 175 in response to the erasing or writing of information in flash memory 120 that correspond to the cache lines to avoid incoherency between cache memory 175 and flash memory 120.

If information is stored or cached in cache memory 175 corresponding to a particular address, or address range, in flash memory 120, and a write or erase operation is performed using that address or address range, then the information cached for that address or address range may be invalidated to avoid incoherency between cache memory 175 and flash memory 120.

In one embodiment, to avoid incoherency between cache memory 175 and flash memory 120 the entire contents of cache memory 175 may be invalidated in response to any write or erase operation issued to flash memory 120. In an alternate embodiment, to avoid incoherency between cache memory 175 and flash memory 120 only a portion of the contents stored in cache memory 175, e.g., one cache line, is invalidated in response to a write or erase operation issued to flash memory 120.

In a processor that requires use of its cache memory to perform a synchronous burst read operation from external memory, in one embodiment, the invalidating of cache lines discussed above may be used to implement the synchronous burst read operation for external memory. For example, in an embodiment where processor 110 requires use of data cache 170 to perform a synchronous burst read from external memory coupled to processor 110, a synchronous burst read of information stored in flash memory 120 may be implemented by adding software to avoid incoherency between data cache 170 and flash memory 120. In one embodiment, avoiding incoherency may be achieved as discussed above, e.g., by invalidating all or part of the contents cached in data cache 170 that correspond to information stored in flash memory 120 that is altered in response to a flash write operation or a flash erase operation.

Although the scope of the present invention is not limited in this respect, as an example, a synchronous burst read operation may comprise providing a starting address of where to begin to read information stored in flash memory 120. Next, a predetermined number of bytes may be fetched beginning at the starting address, e.g., 16 or 32 bytes, at a rate of, e.g., two or four bytes per clock cycle.

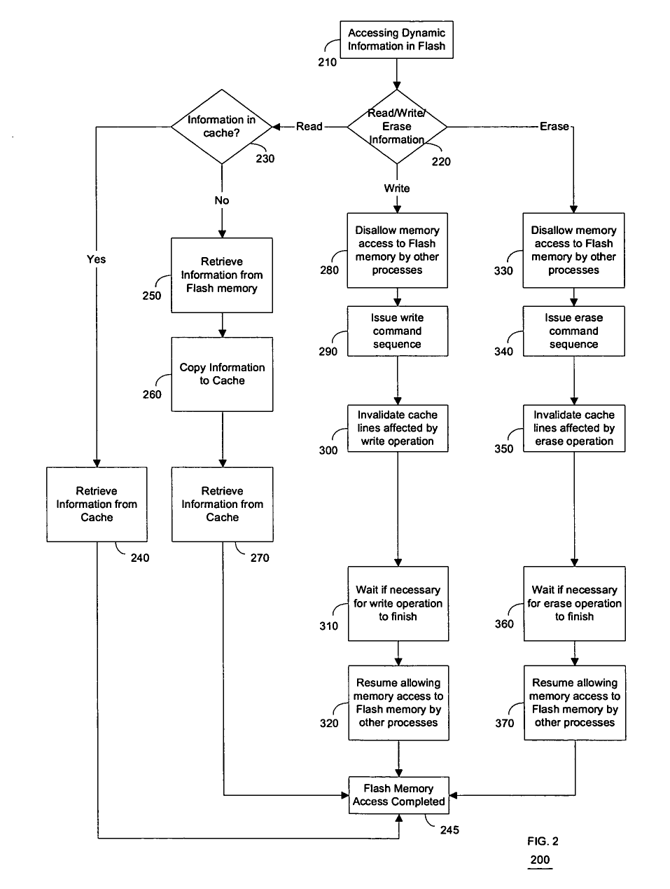

Turning to FIG. 2, what is shown is a flow diagram illustrating a method 200 to access dynamic or alterable information from flash memory 120 (FIG. 1) in accordance with an embodiment of the present invention. This method will be described with reference to system 100 of FIG. 1.

Method 200 may begin with accessing dynamic information stored in flash memory 120 (block 210). This may include issuing a read, write, or erase command to flash memory 120. The memory access command may be sent to cache controller 180 and memory controller 190, which determines what operation is desired (diamond 220). Alternatively, system driver software may determine what operation is desired (diamond 220). If it is determined that a read command was issued, then cache controller 180 may determine whether the dynamic information requested from flash memory 120 for retrieval is available in cache memory 175 (diamond 230).

If the requested dynamic information is found in cache memory 175, then the information is retrieved from cache memory 175 (block 240) rather than flash memory 120. At this point, the flash memory access, i.e., the read operation, is complete (block 245).

If the dynamic information sought or requested by the read request is not found in cache memory 175, then the read request is sent to flash memory 120 and the information is retrieved from flash memory 120 (block 250). In one embodiment, after the information is retrieved from flash memory 120, the information may be cached in, i.e., copied to, cache memory 175 from flash memory 120 (block 260). The dynamic information may be transferred from flash memory 120 to cache memory 175 using a synchronous burst read operation. Then, the information requested through the read operation may be retrieved from cache memory 175 (block 270). At this point, the flash memory access, i.e., the read operation, is complete (block 245).

In an alternate embodiment, in response to the read request, dynamic information may be transferred directly to CPU core 150 rather than going through cache 175 to retrieve the requested information, and this information may also be transferred to, and stored in, cache memory 175.

If it is determined that a write command was issued to write dynamic information to flash memory 120, then memory controller 190 may disallow memory access to flash memory 120 by other hardware, or by other software processes or threads (block 280). Alternatively, system software may disallow memory access to flash memory 120 by other hardware, or by other software processes or threads (block 280). This may be done to prevent other memory accesses to flash memory 120 while writing dynamic information to flash memory 120. Next, memory controller 190 may issue the write command sequence to write the dynamic information to flash memory 120 (block 290). This may include transferring the write command, the write address, and the write information to flash memory 120.

Either during the same time or after the write command sequence is issued, a request may be sent to cache controller 180 to invalidate any cache lines stored in cache memory 175 in response to the writing of dynamic information to flash memory 120 to avoid incoherency between cache memory 175 and flash memory 120. For example, any cache lines affected by the write operation are invalided (block 300). In other words, any cache lines that have information that correspond to dynamic flash information stored at the address range that is being written to in flash memory 120 are invalidated. It should be noted, that in some cases, no cache lines may be invalided. For example, if the information stored in flash at the write address is not cached in cache memory 175, then no cache lines will be invalidated.

Next, a wait operation may be performed to wait, if necessary, for the write operation to flash memory 120 to finish (block 310). Then, memory controller 190 or system software may resume allowing memory access to flash memory 120 by other hardware or by other software processes or threads (block 320). At this point, the flash memory access, i.e., the write operation, is complete (block 245).

If it is determined that an erase command was issued to erase information in flash memory 120, then memory controller 190 may disallow memory access to flash memory 120 by other hardware, or by other software processes or threads (block 330). Alternatively, system software may disallow memory access to flash memory 120 by other hardware, or by other software processes or threads (block 330). This may be done to prevent other memory accesses to flash memory 120 while erasing information from flash memory 120. Next, memory controller 190 may issue the erase command sequence to erase information in flash memory 120 (block 340). This may include transferring the erase command and the erase address which indicates the address range this is to be erased.

Either during the same time or after the erase command sequence is issued, a request may be sent to cache controller 180 to invalidate any cache lines stored in cache memory 175 in response to the erasing of information in flash memory 120 to avoid incoherency between cache memory 175 and flash memory 120. For example, any cache lines affected by the erase operation are invalided (block 350). In other words, any cache lines that have information that correspond to the information stored at the address range or location that is being erased in flash memory 120 are invalidated.

Next, a wait operation may be performed to wait, if necessary, for the erase operation to flash memory 120 to finish (block 360). Then, memory controller 190 or system software may resume allowing memory access to flash memory 120 by other hardware or by other software processes or threads (block 370). At this point, the flash memory access, i.e., the erase operation, is complete (block 245).

Accordingly, as discussed above, in one embodiment, the present invention provides a method to avoid incoherency between a cache memory (e.g., cache memory 175) and a flash memory (e.g., flash memory 120) so that for any alterable flash information that is cached in the cache memory, a copy also exists in the flash memory. The method may include invalidating at least one cache line of information stored in a cache memory in response to a flash write operation or a flash erase operation, wherein the flash write and erase operations changes, updates, or alters dynamic information stored in the flash memory.

In an alternate embodiment, a method to avoid incoherency between a cache memory (e.g., cache memory 175) and a flash memory (e.g., flash memory 120) may comprise invalidating at least one cache line of information stored in a cache memory in response to an operation that makes information inaccessible in a flash memory. In one example, the operation that makes information inaccessible may comprise locking a particular section or portion of the flash memory to prevent read-access to information stored in that particular locked section. This may be accomplished by requiring a password to access a selected portion of flash memory 120. Locking a particular section or region of flash memory 120 alone without the invalidating of information in cache memory 175 may create incoherency between cache memory 175 and flash memory 120.

In one example, the method may include invalidating all cache lines that have information that correspond to the address range that is made inaccessible in the flash memory. In another example, cache memory 175 may store one or more cache lines of information that correspond to information stored at a particular address in flash memory 120. In other words, cache memory 175 may store at least one cache line of information that includes a copy of the information stored at a particular address in flash memory 120. In this example, the method may include invalidating the at least one cache line of information in response to an operation that makes the information stored at the particular address in flash memory 120 inaccessible.

In an alternate embodiment, a method to avoid incoherency between a cache memory (e.g., cache memory 175) and a flash memory (e.g., flash memory 120) may comprise invalidating at least one cache line of information stored in the cache memory in response to an operation that moves information from a first region of the flash memory to a second region of the flash memory to improve wear leveling in the flash memory. In one example, the method may include invalidating all the cache lines that have a copy of the information stored in the first region of the flash memory in response to the moving of information from the first region of the flash memory. Moving information from one area of flash memory 120 to another area of flash memory 120 alone without the invalidating of information in cache memory 175 may create incoherency between cache memory 175 and flash memory 120.

As discussed above, flash memory 120 may comprise one or more chips. Therefore, the moving of information within flash memory 120 may include moving information within one chip or across multiple chips.

In another example, cache memory 175 may store one or more cache lines of information that correspond to information stored in a first region of flash memory 120. In other words, cache memory 175 may store one or more cache lines of information that include a copy of the information stored in the first region of flash memory 120. In this example, the method may include invalidating all the cache lines of information corresponding to the first region in flash memory 120 in response to an operation that moves the information stored in the first region of flash memory 120 to a second region of flash memory 120.

Accordingly, as discussed above, methods and apparatuses to avoid incoherency between a cache memory and a flash memory are provided.

In one embodiment, a method may include transmitting or initiating a request to invalidate at least one cache line of information stored in a cache memory in response to a flash erase operation, a flash write operation, an operation that makes information inaccessible in a flash memory, or an operation that moves information from one region of a flash memory to another region of the flash memory to improve wear leveling in the flash memory. All of these flash events may be referred to as incoherency-causing events. In other words, any of these events alone may cause incoherency between a flash memory and a cache memory that is adapted to cache contents of the flash memory.

In one embodiment, an apparatus (e.g., processor 110) may include a cache memory (e.g., memory 175) and a controller (e.g., cache controller 180) adapted to invalidate at least one cache line of information stored in the cache memory to avoid incoherency between the cache memory and a flash memory in response to a flash erase operation, a flash write operation, an operation that makes information inaccessible in a flash memory, or an operation that moves information from one region of the flash memory to another region of the flash memory.

Embodiments may be implemented in a program. As such, these embodiments may be stored on a storage medium having stored thereon instructions which can be used to program a system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), electrically erasable programmable read-only memories (EEPROMs), flash memories, a silicon-oxide-nitride-oxide-silicon (SONOS) memory, magnetic or optical cards, or any type of media suitable for storing electronic instructions. Similarly, embodiments may be implemented as software modules executed by a programmable control device, such as a computer processor or a custom designed state machine.

Although the embodiments above discuss using a flash memory, i.e., flash memory 120, it should be noted that this is not a limitation of the present invention. Embodiments of the present invention may also be used with other types of nonvolatile memories, e.g., a ferroelectric polymer memory, although the scope of the present invention is not limited in this respect. In one embodiment, a method to avoid incoherency between a cache memory and a nonvolatile memory is provided that includes invalidating at least one cache line of information stored in the cache memory in response to a write operation to the nonvolatile memory, an erase operation to the nonvolatile memory, an operation that makes information inaccessible in the nonvolatile memory, or an operation that moves information from one region of the nonvolatile memory to another region of the nonvolatile memory. In one example, the nonvolatile memory may be a flash memory and in another example the nonvolatile memory may be a polymer memory such as, e.g., a ferroelectric polymer memory.

In addition, the methods discussed above to avoid incoherency could be applied to systems that include a nonvolatile memory that have a command based interface, e.g., a flash like interface and where the memory technology is flash or some other type of nonvolatile memory. Further, the methods described above may be applied to systems that include a nonvolatile memory that has a windowed interface, e.g., a data flash (e.g., a NAND flash) or other nonvolatile memories that require loading a buffer to read information from the nonvolatile memory.

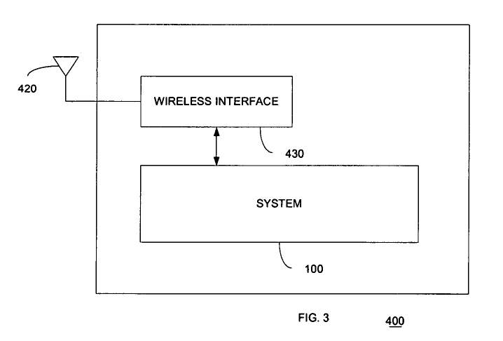

Turning to FIG. 3, shown is a block diagram illustrating a wireless device 400 in accordance with an embodiment of the present invention. In one embodiment, wireless device 400 may use the methods discussed above and may include computing system 100 (FIG. 1).

As is shown in FIG. 3, wireless device 400 may include an antenna 420 coupled to a processor (e.g., processor 110) of system 100 via a wireless interface 430. In various embodiments, antenna 420 may be a dipole antenna, helical antenna or another antenna adapted to wirelessly communicate information. Wireless interface 430 may be adapted to process radio frequency (RF) and baseband signals using wireless protocols and may include a wireless transceiver.

Wireless device 400 may be a personal digital assistant (PDA), a laptop or portable computer with wireless capability, a web tablet, a wireless telephone (e.g., cordless or cellular phone), a pager, an instant messaging device, a digital music player, a digital camera, or other devices that may be adapted to transmit and/or receive information wirelessly. Wireless device 400 may be used in any of the following systems: a wireless personal area network (WPAN) system, a wireless local area network (WLAN) system, a wireless metropolitan area network (WMAN) system, or a wireless wide area network (WWAN) system such as, for example, a cellular system.

An example of a WLAN system includes a system substantially based on an Industrial Electrical and Electronics Engineers (IEEE) 802.11 standard. An example of a WMAN system includes a system substantially based on an Industrial Electrical and Electronics Engineers (IEEE) 802.16 standard. An example of a WPAN system includes a system substantially based on the Bluetooth™ standard (Bluetooth is a registered trademark of the Bluetooth Special Interest Group). Another example of a WPAN system includes a system substantially based on an Industrial Electrical and Electronics Engineers (IEEE) 802.15 standard such as, for example, the IEEE 802.15.3a specification using ultrawideband (UWB) technology.

Examples of cellular systems include: Code Division Multiple Access (CDMA) cellular radiotelephone communication systems, Global System for Mobile Communications (GSM) cellular radiotelephone systems, Enhanced data for GSM Evolution (EDGE) systems, North American Digital Cellular (NADC) cellular radiotelephone systems, Time Division Multiple Access (TDMA) systems, Extended-TDMA (E-TDMA) cellular radiotelephone systems, GPRS, third generation (3G) systems like Wide-band CDMA (WCDMA), CDMA-2000, Universal Mobile Telecommunications System (UMTS), or the like.

Although computing system 100 is illustrated as being used in a wireless device in one embodiment, this is not a limitation of the present invention. In alternate embodiments system 100 may be used in non-wireless devices such as, for example, a server, a desktop, or an embedded device not adapted to wirelessly communicate information.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
invalidating at least one cache line of information stored in a cache memory in response to a flash write operation or a flash erase operation to avoid incoherency between the cache memory and a flash memory.

2. The method of claim 1, wherein invalidating comprises invalidating all information stored in the cache memory in response to the flash write operation or the flash erase operation to avoid incoherency between the cache memory and the flash memory.

3. The method of claim 1, wherein the at least one cache line of information includes a copy of dynamic information stored at an address in the flash memory and wherein invalidating comprises invalidating the at least one cache line of information in response to the flash write operation or the flash erase operation that alters the dynamic information stored at the address in the flash memory.

4. The method of claim 1, wherein invalidating comprises invalidating all cache lines stored in the cache memory affected by the flash erase operation or the flash write operation.

5. The method of claim 1, wherein invalidating comprises invalidating all cache lines stored in the cache memory that have information that correspond to information stored in the flash memory at the address range that is being written to, or erased in the flash memory.

6. The method of claim 1, further comprising reading information from the flash memory using a synchronous burst read operation, wherein reading comprises transferring information from the flash memory to the cache memory using a synchronous burst read operation.

7. A method to avoid incoherency between the cache memory and the flash memory, comprising:
invalidating at least one cache line of information stored in the cache memory in response to an operation that makes information inaccessible in the flash memory.

8. The method of claim 7, wherein the operation that makes information inaccessible comprises locking a section of the flash memory to prevent read-access to information stored in the section.

9. The method of claim 7, wherein the at least one cache line of information corresponds to information stored at a particular address in the flash memory and wherein invalidating comprises invalidating the at least one cache line of information in response to an operation that makes the information stored at the particular address in the flash memory inaccessible using a flash read operation.

10. A method to avoid incoherency between a cache memory and a flash memory, comprising:
invalidating at least one cache line of information stored in the cache memory in response to moving information from a first region of a flash memory to a second region of the flash memory.

11. The method of claim 10, wherein invalidating comprises invalidating all cache lines that have a copy of information stored in the first region of the flash memory.

12. The method of claim 10, wherein the at least one cache line of information includes a copy of information stored in the first region of the flash memory and wherein invalidating comprises invalidating the at least one cache line of information in response to an operation that moves the information stored in the first region of the flash memory to the second region of the flash memory to improve wear leveling in the flash memory.

13. An article comprising a storage medium having stored thereon instructions, that, when executed by a computing platform, result in: invalidating at least one cache line of information stored in a cache memory to avoid incoherency between the cache memory and a flash memory in response to a flash erase operation, a flash write operation, an operation that makes information inaccessible in the flash memory, or an operation that moves information from one region of the flash memory to another region of the flash memory.

14. The article of claim 13, wherein the instructions, when executed, further result in: reading information from the flash memory using a synchronous burst read operation, wherein reading comprises transferring information from the flash memory to the cache memory using a synchronous burst read operation.

15. The article of claim 13, wherein the operation that makes information inaccessible comprises locking a section of the flash memory to prevent read-access to information stored in the section.

16. An apparatus, comprising:
a cache memory; and
a controller adapted to invalidate at least one cache line of information stored in the cache memory to avoid incoherency between the cache memory and a flash memory in response to a flash erase operation, a flash write operation, an operation that makes information inaccessible in a flash memory, or an operation that moves information from one region of the flash memory to another region of the flash memory.

17. The apparatus of claim 16, further comprising a central processing unit (CPU) core coupled to the controller.

18. The apparatus of claim 16, wherein the cache memory comprises:
an instruction cache coupled to the controller; and
a data cache coupled to the controller.

19. A system, comprising:
an antenna; and
a processor coupled to the antenna, wherein the processor comprises:
a cache memory and
a controller adapted to invalidate at least one cache line of information stored in the cache memory to avoid incoherency between the cache memory and a flash memory in response to a flash erase operation, a flash write operation, an operation that makes information inaccessible in a flash memory, or an operation that moves information from one region of the flash memory to another region of the flash memory.

20. The system of claim 19, wherein the processor further comprises a central processing unit (CPU) core coupled to the controller.

21. The system of claim 19, wherein the system is a wireless phone.

22. A method, comprising:
copying alterable information from a flash memory to a cache memory.

23. The method of claim 22, wherein the alterable information is alterable data or alterable code.

24. The method of claim 23, wherein the alterable code is operating system (O/S) code or a software application.

25. The method of claim 23, wherein the alterable data is a java applet, ring tone data, or telephone number data.

26. The method of claim 22, further comprising copying the alterable information from the cache memory to a central processing unit (CPU) core.

27. The method of claim 22, wherein the cache memory is an instruction cache memory.

28. The method of claim 22, wherein the cache memory is a data cache memory.

29. The method of claim 22, further comprising:
writing information to a location in the flash memory; and
invalidating at least one cache line of information stored in the cache memory in response to the writing of information to the location in the flash memory to avoid incoherency between the cache memory and the flash memory, wherein the at least one cache line of information includes a copy of alterable flash information stored at the location in the flash memory that is being written to during the writing.

30. The method of claim 22, further comprising:
erasing information at a location in the flash memory; and
invalidating at least one cache line of information stored in a cache memory in response to the erasing of information in the flash memory to avoid incoherency between the cache memory and the flash memory, wherein the at least one cache line of information includes a copy of alterable flash information that is stored at the location in the flash memory that is being erased by the erasing.

31. A method to avoid incoherency between a cache memory and a nonvolatile memory, comprising:
invalidating at least one cache line of information stored in the cache memory in response to a write operation to the nonvolatile memory, an erase operation to the nonvolatile memory, an operation that makes information inaccessible in the nonvolatile memory, or an operation that moves information from one region of the nonvolatile memory to another region of the nonvolatile memory, wherein the nonvolatile memory is a nonvolatile memory other than a disk memory.

32. The method of claim 31, wherein the nonvolatile memory is a polymer memory.
